(19) United States
(12) Patent Application Publication
(10) Pub. No.: US 2003/0091334 A1
(43) Pub. Date: May 15, 2003

(54) Optical disk recording apparatus and method

(75) Inventor: Hideto Noguchi, Hitachinaka (JP)

Correspondence Address: McDermott, Will & Emery, 600, 13th Street, N.W., Washington, DC, 20005-3096, US

(73) Assignee: Hitachi, Ltd.

(21) Appl. No.: 10/092,923

(22) Filed: Mar. 8, 2002

(30) Foreign Application Priority Data
Nov. 14, 2001 (JP) 2001-348165

(51) Int. Cl. H04N 5/781

(52) U.S. Cl. 386/70; 359/126

(57) ABSTRACT

An optical disk recording apparatus includes a recording unit for recording at least image data on an optical disk medium and a thumbnail generating unit for generating, for each partial recording section of image data to be recorded on the optical disk medium, thumbnail data of a particular image associated with the partial recording section, the thumbnail data being recorded on the optical disk medium. When a particular operation is conducted, the particular image is read for each of the partial recording sections, thumbnail data is generated for the particular image, and the thumbnail data of a plurality of images is recorded on the optical disk medium in the form of a string of data.

### BACKGROUND OF THE INVENTION

The present invention relates to a recording apparatus and a recording method using an optical disk medium, and in particular, to a recording apparatus in which a thumbnail representing the contents of a mobile picture, a till picture, a still picture with voice and sound, or the like is used to easily retrieve a desired scene.

Recording and reproducing apparatuses each using an optical disk has been used today. According to one of the standards applied to optical disks for such apparatuses, the disks can be classified into rewritable disks such as a digital versatile disk (DVD) random access memory (RAM) on which information written over previously information and write-once disks such as a DVD-R (DVD Recordable) on which information cannot be written over previously information.

Recording and erasure of information can be repeatedly carried out on the DVD-RAM (DVD Random Access Memory) as a representative rewritable medium for the recording and reproducing apparatus. However, the information recorded thereon can be reproduced only by an apparatus having an appropriate function for such a DVD-RAM.

On the other hand, a video image once recorded on the DVD-R as a representative write-once medium for the recording and reproducing apparatus cannot be easily erased. However, by executing a write terminating operations called “finalization” for the information recorded on the DVD-R, the information can be reproduced by a DVD widely used in the world.

As a result of the finalization of a DVD-R, there are generated, for example, information of an index of the optical disk so that the disk can be reproduced by a DVD player and information indicating an end of data stored on the optical disk to thereby prevent an overrun of an optical pickup device for the disk.

Two kinds of image recording apparatuses, namely, a recording apparatus only for a rewritable optical disk and a recording apparatus for rewritable and write-once optical disks have been put to practices today.

In many recording and reproducing apparatuses using the optical disk, to take advantage of the random accessibility of such an optical disk, thumbnail images representing respective images recorded on the disk are displayed in a list on a liquid-crystal monitor screen or the like to facilitate retrieval of a desired image.

The thumbnail list or thumbnail includes images produced by minimizing video images of representative scenes recorded on the disk. For example, the representative scenes are typically images already recorded when a recording operation is started, images obtained at a fixed interval of time, or images obtained when a scene is changed. In the following description of the present invention, the thumbnail includes recorded images obtained when a recording operation is started.

An operation to display a list of thumbnail images is called “navigation”. FIG. 1 shows an example of a navigation screen image. The navigation screen 101 displays a plurality of thumbnails 102. One unit of recorded images represented by one thumbnail will be referred to as “scene” hereinbelow. An information display item 103 indicates information such as a day and time when a video image is shot. However, the information is not limited to the day and time but may indicate, for example, a title inputted by the user and a place at which the image is shot. An indicator 104 indicates a location where the thumbnail images are displayed.

In this situation of the navigation image displayed on the screen, the user can easily conduct operations for recorded images by use of buttons of the recording and reproducing apparatus, for example, to reproduce or to erase a desired scene record on the disk.

To smoothly achieve the navigation screen, it is important to display thumbnail images at a high speed. JP-A-2001-111963 describes one of the methods to display the navigation image. This method has been put to practices. In this method, when data of an image is recorded on a disk, thumbnail data or minimized image data for a thumbnail of the image is also generated to be recorded on the disk.

Referring now to FIG. 2, an outline of an optical disk associated with the technique will be described before the technique itself. FIG. 2 shows an example of a general configuration of an optical disk. The optical disk 201 includes a fixed area 202 along an inner circumference thereof is used to record index information such as table of contents (TOC) to facilitate disk access and a data area 203 to write video image data and thumbnail data.

On an optical disk of rewritable type, data can be recorded on the data area 203 beginning at a desired start point. To write the data, it is allowed to use separated areas which are not physically continuous on the disk 201.

On an optical disk of write-one type, data must be sequentially and continuously written on the data area 203 beginning at an area near the internal circumference toward an outer circumference of the disk 201. When a discontinuous areas are used to record data thereon, these areas must be separated by a distance equal to or less than a predetermined area determined according to performance of the associated system.

Under the condition of the disk, description will be given a case in which the known example is applied to a write-one disk medium and a rewritable disk medium by referring to FIG. 3.

FIG. 3 shows a data layout of data written on a rewritable optical disk according to the prior art example. The data is actually recorded in a circumferential direction on the optical disk. However, FIG. 3 shows data items linearly arranged on the disk. In FIG. 3, an area on the left corresponds to an inner circumferential area of the area 203 of FIG. 2 and an area on the right corresponds to an outer circumferential area of the area 203 of FIG. 2. FIG. 3 includes data items of three scenes. Recorded data items 301, 302, and 303 respectively correspond to scenes 1, 2, and 3. Thumbnail data items 311, 312, and 313 respectively correspond to scenes 1, 2, and 3. These data items of three scenes are recorded in a recording sequence of data items 301, 311, 302, 312, 303, and 313. An area 300 is exclusively used to write thumbnail data.

On the other hand, when the data items including record data and thumbnail data are written on a write-once optical disk in substantially the same recording sequence used for the rewritable optical disk, that is, in the recording sequence in which record data and thumbnail data are alternately and repeatedly recorded on the disk, the data items are arranged in a data layout on the disk as shown in FIG. 4. This is because the data items must be sequentially and continuously written on the write-once disk beginning at an area near an inner circumference toward an outer circumference of the disk. The data layout of FIG. 4 shows a result of a recording operation almost same as that of FIG. 3. Data items 401, 402, and 403 correspond to scenes 1, 2, and 3, respectively. Thumbnail data items 411, 412, and 413 correspond to scenes 1, 2, and 3, respectively. An area 421 is reserved and is not used to record data.

According to the prior art, since data can be recorded beginning at a desired position on the rewritable optical disk, the area 300 can be reserved only to record thumbnail data items. The thumbnail data items can be therefore continuously written therein. This increases the navigation speed. Additionally, since the thumbnail data items can be continuously recorded on the optical disk, it is possible to reduce the number of seek operations which are used to search for a desired data item on the disk and which delay an overall data read operation of the optical disk in some cases. This also leads to increase of the operation speed of the navigation.

However, when a write-once optical disk is employed, data items are sequentially and continuously written such that the data items are added to the data items beforehand written thereon. Therefore, the thumbnail data items 411 to 413 cannot be continuously arranged at one location, namely, the data items are dispersed on the disk as shown in FIG. 4. When the thumbnail data items thus dispersed on the disk are used to display a navigation screen image, the seek operation is required to read the thumbnail data items. This resultantly leads to a problem that the navigation speed is lowered.

### SUMMARY OF THE INVENTION

It is therefore an object of the present invention to record the thumbnail data items in a string to increase the navigation speed. Another object of the present invention is to record the thumbnail data items according to a disk type so that the navigation speed is increased also for a write-once optical disk.

To achieve the object above, there is provided an optical disk recording apparatus, comprising recording means for recording at least image data of mobile picture and control information thereof on an optical disk medium; and thumbnail generating means for generating, for each partial recording section of image data of mobile picture to be recorded on said optical disk medium, thumbnail data of a particular image associated with the partial recording section, the thumbnail data being recorded on said optical disk medium by said recording means, wherein when a particular operation is conducted, the particular image is read for each of the partial recording sections; said thumbnail generating means generates thumbnail data using the particular image read for said each partial recording section; said recording means recording the thumbnail data of a plurality of images in the form of a string of data.

According to the present invention, said optical disk medium is of a write-once type; and when an operation for write processing termination is conducted as the particular operation, the string of thumbnail data is recorded.

According to the present invention, there is provided an optical disk recording apparatus capable of recording image data of mobile picture and control information thereof on a plurality of types of optical disk media, comprising recording means for recording at least image data of mobile picture on an optical disk medium; thumbnail generating means for generating, for each partial recording section of image data of mobile picture to be recorded on said optical disk medium, thumbnail data of a particular image associated with the partial recording section, the thumbnail data being recorded on said optical disk medium by said recording means; and means for determining a type of said optical disk medium and for changing the processing to generate and to record thumbnail data in association with the recording of the image of mobile picture.

According to the present invention, when said type determining means determines that said optical disk medium is of a write-once type and when an operation for write processing termination is conducted, the string of thumbnail data is recorded.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of navigation processing;

FIG. 2 is a diagram showing an example of a data layout in areas on an optical disk;

FIG. 3 is a diagram for explaining sequences of thumbnail data items and record data items on a rewritable optical disk using a prior art example;

FIG. 4 is a diagram for explaining sequences of thumbnail data items and record data items on a write-once optical disk using a prior art example;

FIG. 5 is a diagram showing an embodiment of a hardware configuration according to the present invention;

FIG. 6 is a flowchart showing a procedure to execute processing in the embodiment according to the present invention;

FIG. 7 is a flowchart showing a detailed processing procedure to record data on a rewritable recording medium in the embodiment according to the present invention;

FIG. 8 is a flowchart showing a detailed processing procedure to record data on a write-once recording medium in the embodiment according to the present invention;

FIG. 9 is a flowchart showing a detailed processing procedure to finalize a write-once recording medium in the embodiment according to the present invention; and

FIG. 10 is a diagram for explaining sequences of thumbnail data items and record data items on a write-once optical disk in the embodiment according to the present invention.

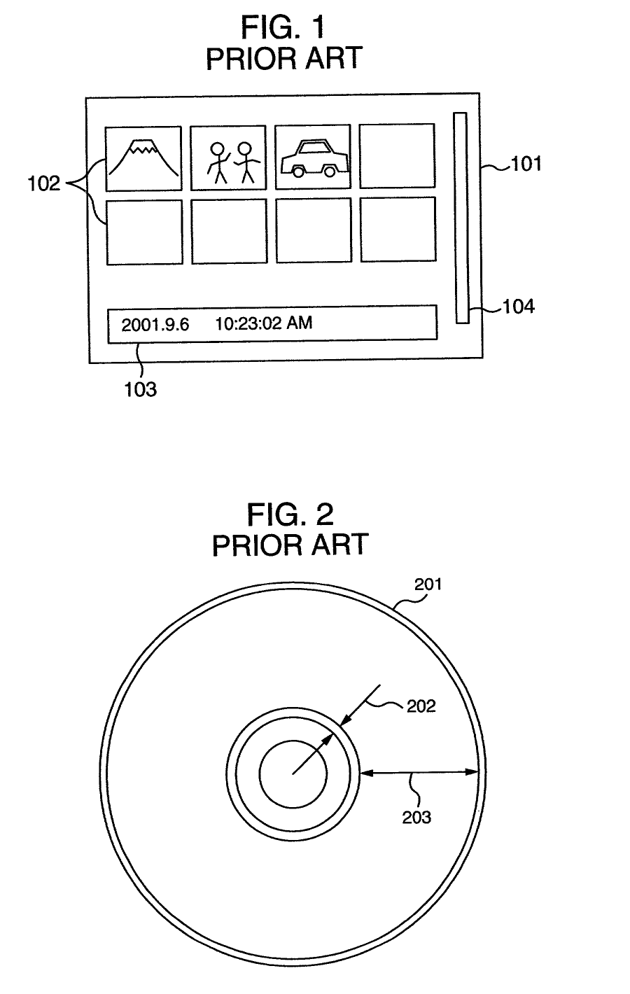

### DESCRIPTION OF THE EMBODIMENTS

Referring now to the drawings, description will now be given of an embodiment in which the present invention is applied to a video camera. It is assumed according to the present invention that the recording and reproducing apparatus can handle a rewritable optical disk and a write-once optical disk.

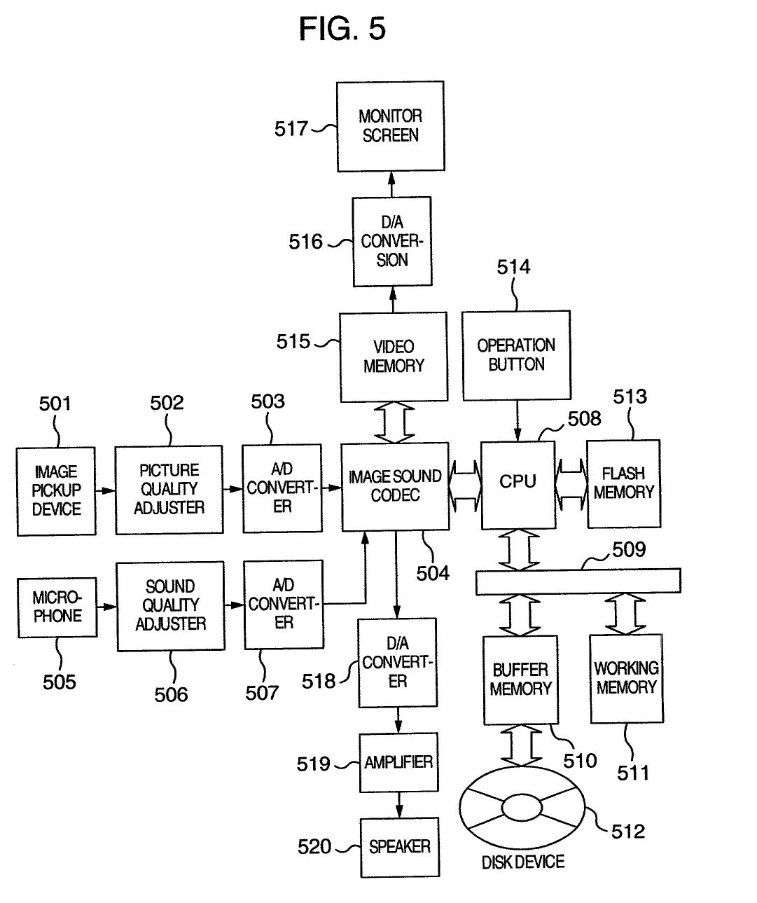

FIG. 5 shows a configuration of an embodiment for a video camera according to the present invention.

The configuration shown in FIG. 5 includes an image pickup device 501 to convert a signal of an image into an electric signal, an analog-to-digital (A/D) converter 503 to convert an analog signal into a digital signal, an image sound coded circuit 504 to execute various process for an image and sound, a microphone 505, a sound quality adjusting circuit 506 to conduct processing such as level adjustment, an A/D converter 507 for voice and sound, a central processing unit (CPU) 508 to conduct various control operations and to execute various processing such as determination of a disk type, a buffer memory 510 to temporarily store record data, a working memory 511 to store thumbnail data and other data, an optical disk device 512 having a function to write data on and to read data from an optical disk medium and a function to conduct various control operations, a flash memory 513, an operation button 514, a video memory 515 to process a video digital signal from the image sound coded circuit 504, a digital-to-analog (D/A) converter to convert a video digital signal into an analog signal, a monitor screen 517 to display images of, for example, thumbnails, a sound D/A converter 518, an amplifier 519, and a speaker 520.

Operation of the system to record data on a disk will be described. An image of an object produced by the image pickup device 501 is fed to the picture quality adjuster 502. The adjuster 502 conducts correction of hue and brightness to improve the picture quality. An output signal thus obtained from the adjuster 502 is fed to the A/D converter 503 and is converted by the converter 503 into a digital signal to be fed to the codec circuit 504. On the other hand, a sound signal obtained by the microphone is fed to the sound quality adjuster 506. The adjuster 506 conducts operations such as level adjustment and reduction of sound of a wind. A signal resultantly produced from the adjuster 506 is then converted by the A/D converter 507 into a digital signal to be delivered to the image sound codec circuit 504. The codec 504 encodes or decodes an input digital signal. In an encoding operation, the codec 504 mixes an image digital signal with a sound digital signal to produce a digital code called “system stream” in which the image is synchronizes with the sound. In a decoding operation to decode a system stream, the codec 504 obtains an image digital signal and a sound digital signal from the input system stream. An example of the encoding operation is conducted according to an encoding method using information compression represented by standards of a motion picture experts group (MPEG).

The system stream created by the image sound codec 504 is fed by the CPU 508 through a system bus 509 to be accumulated in the buffer memory 510. The CPU 508 can freely access the buffer memory 510 and the working memory 511, which will be described later, via the system bus 509. The system stream accumulated in the buffer memory 510 is then sequentially written by the disk device 512 on an optical disk. The buffer memory 510 is disposed to continually conduct data input and output operations even if read and write operations on the optical disk are instantaneously or temporarily stopped, for example, due to vibration of the disk device 512.

The CPU 508 stores the system stream created by the codec 504 in the buffer memory 510. The CPU 508 also generates thumbnail data using the system stream to write the data via the buffer memory 510 onto an optical disk medium and determines a type of the optical disk installed in the disk device 512. The working memory 511 is used by the CPU 508 to execute various processing. The flash memory 513 stores software for the CPU 508.

The operation button 514 includes a reproduction button, a record button, a navigation start button, a finalization button, and the like. The user can control operation of the system by operation the button 514. Information of operation conducted by the user for the button 514 is delivered to the CPU 508.

Next, description will be given of an operation to reproduce an image in the system. A system stream read from the optical disk device 512 is accumulated in the buffer memory 510. The CPU 508 obtains the system stream via the system bus 509. The CPU 508 outputs the system stream to the codec circuit 504. The codec 504 decodes the system stream to obtain a video digital signal and an audio digital signal. The CPU 508 develops the video digital signal in the video memory 515 to process the signal. A video signal resulted from the processing in the video memory 515 is then converted by the D/A converter 516 into an analog video signal to reproduce an image. The reproduced image is displayed on the monitor screen 517 such as a liquid-crystal display. On the other hand, the audio digital signal is inputted to the D/A converter 518 to be converted into an analog audio signal. The signal is amplified by the amplifier 519 to be fed to the speaker 520. The speaker 520 produces sound according to the received signal. Thumbnail data similarly read from the optical disk device 512 is processed through the buffer memory 510, the system bus 509, the CPU 508, the codec 504, and the video memory 515 so that a thumbnail image is displayed on the monitor screen 517.

The CPU 508 can superimposed an on screen display (OSD) image of, for example, information of time via the codec 504 onto the video signal developed in the video memory 515. The CPU 508 can also generate via the codec 504 the thumbnail image, various graphic images, and the like for the navigation screen.

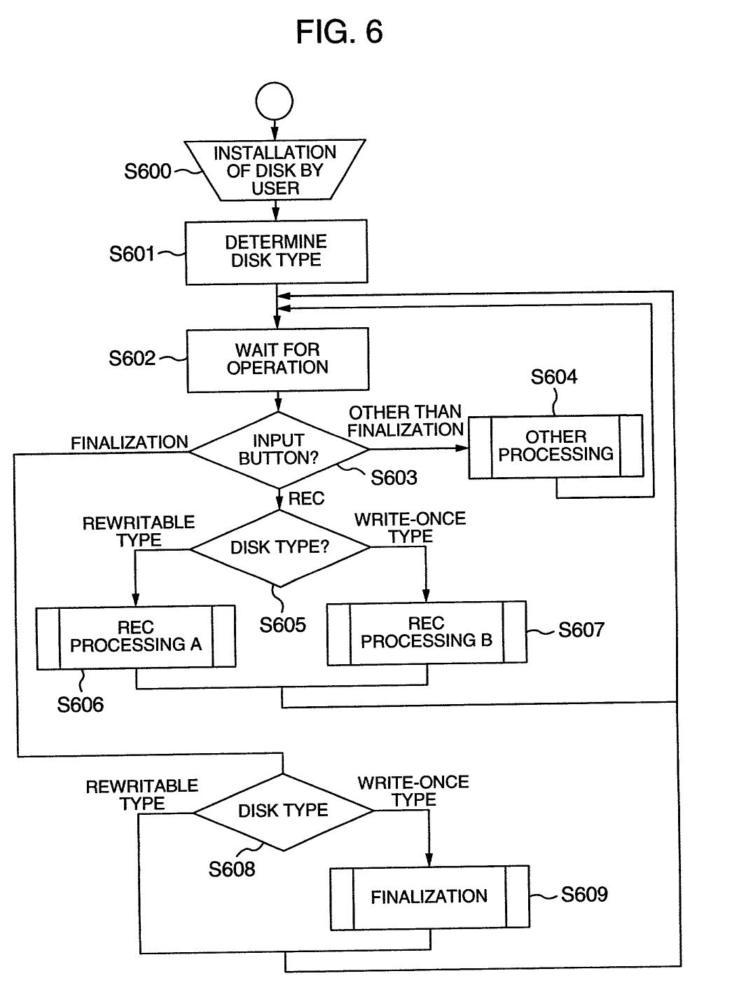

Referring now to FIG. 6, description will be given of software control in a recording operation by the CPU 508 of the system according to the flowchart shown in FIG. 5.

When the user installs a disk in the disk device (S600), disk type recognition processing S601 determines a type, i.e., a rewritable or write-once type of the installed disk. Information of the determined disk type is kept in the CPU 508 of FIG. 5. When the processing S601 is terminated, control enters a wait state S602. Resultantly, the system is set to a state to receive a button operation from the user. In the wait state S602, the system waits for information of an button input from the operation button 514 of FIG. 5.

When REC button is depressed (S603) in this situation, a branch step S603 passes control to a branch step S605. In step S605, the information which is beforehand recognized by the disk type recognition processing S601 and which is kept in the CPU 508 is checked. If the information indicates a rewritable type, step S605 passes control to REC processing A S606. If the information indicates a write-once type, step S605 passes control to REC processing B S607. Details of processing S606 and S607 will be described later. After the processing S606 or S607 is finished, control returns to the wait state S602.

When step S603 determines that Finalize button is depressed, control is passed to a subsequent step similarly according to the information which is beforehand recognized by the disk type recognition processing S601 and which is kept in the CPU 508. If the information indicates a write-once type, step S609 is executed for the finalization and then control returns to the wait state S602. If the information indicates a rewritable type, control returns the wait state S602 without conducting the finalization. Details of processing S609 will be described later.

When step S603 determines that a button other than REC and Finalize buttons is depressed, control is passed to step S604 to execute processing assigned to the depressed button and then control enters the wait state S602. The depression of the button other than REC and Finalize buttons indicates, for example, an operation to change a picture quality mode or a zooming operation in the camera section. However, the processing of step S604 is not directly related to the present invention and will not be described in detail.

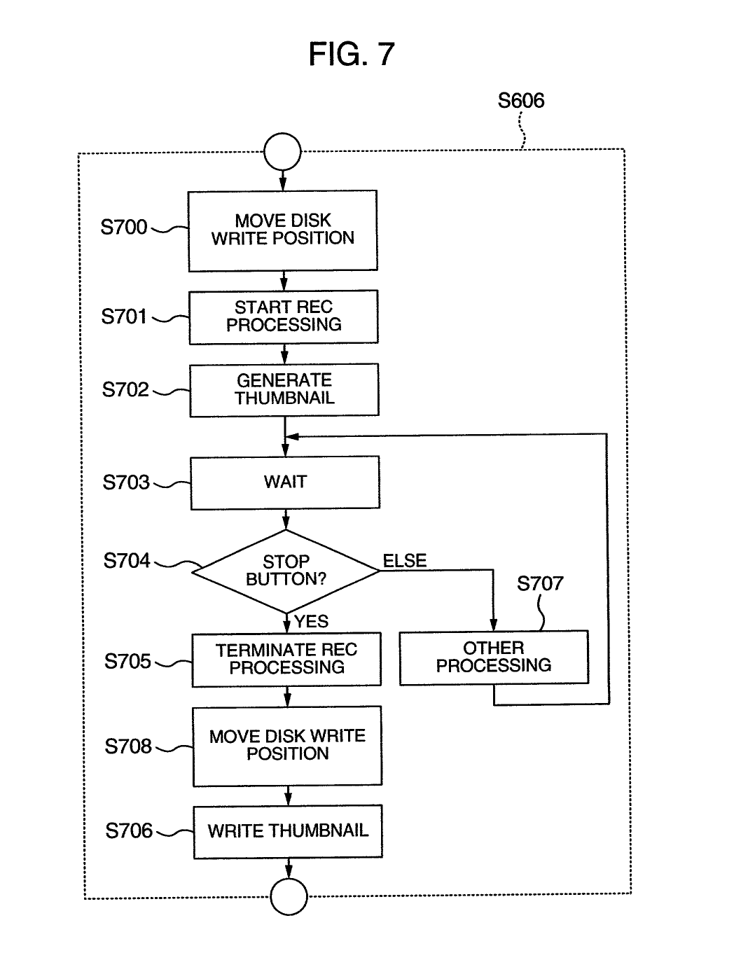

Referring next to FIG. 7, description will be given of REC processing A in step S606 for a rewritable optical disk in FIG. 6.

First, step S700 is executed to move the optical pickup device over an area of the optical disk to write record data to resultantly set a write start position. In step S701, a REC operation is started to execute processing assigned to the REC button.

Next, step S702 is executed to obtain an image at the REC start point as a still picture. The still picture is minimized to be stored as a thumbnail in the working memory 511 of FIG. 5. During the REC processing, the system state is set to the wait state S703. Resultantly, the system is in a state to receive a key operation from the user.

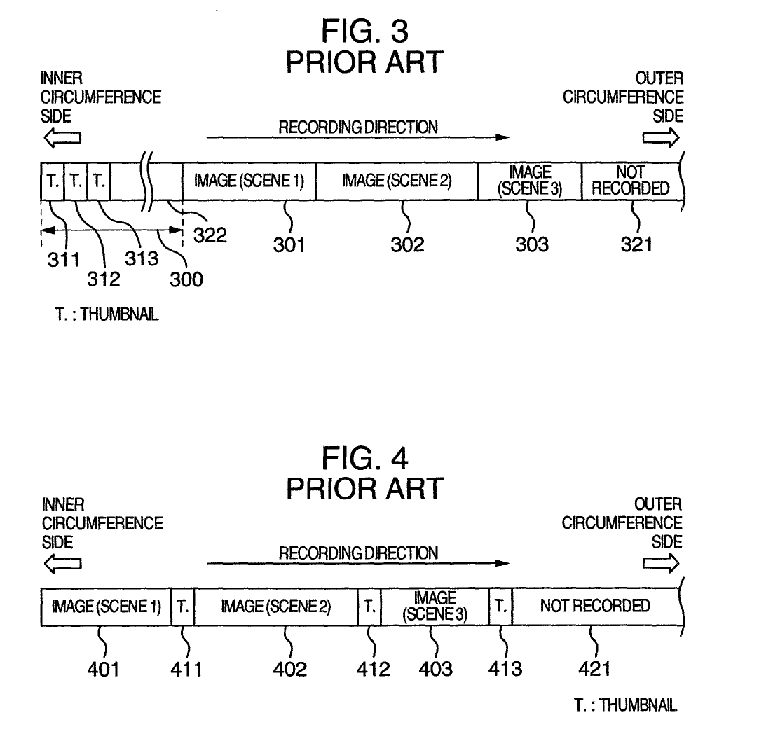

When the user depresses a button thereafter, control is passed by step S704 to processing assigned to the button. If STOP button is depressed, step S705 is executed to terminate the REC processing. That is, a system stream which is accumulated in the buffer memory 510 and which is not written on the recording medium in the optical disk device 512 of FIG. 5 is written on the medium. Next, step S708 is executed such that the pickup is moved to a thumbnail recording area (an area 300 of FIG. 3) on the disk to set the disk write position. Thereafter, step S706 is executed such that thumbnail data which has been generated before and which has been kept in the working memory 511 is written as a string of thumbnail data on the optical disk. The REC processing A of Step S606 is then terminated.

On the other hand, when the user depresses a button other than STOP button, step S707 is executed to execute processing assigned to the depressed button, and then control returns to the wait state S703. The depression of the button other than STOP button indicates, for example, an operation to change a picture quality mode. However, the processing of step S707 is not directly related to the present invention and will not be described in detail.

In the processing described above, the thumbnail data items can be continuously written on the rewritable optical disk as shown in FIG. 3.

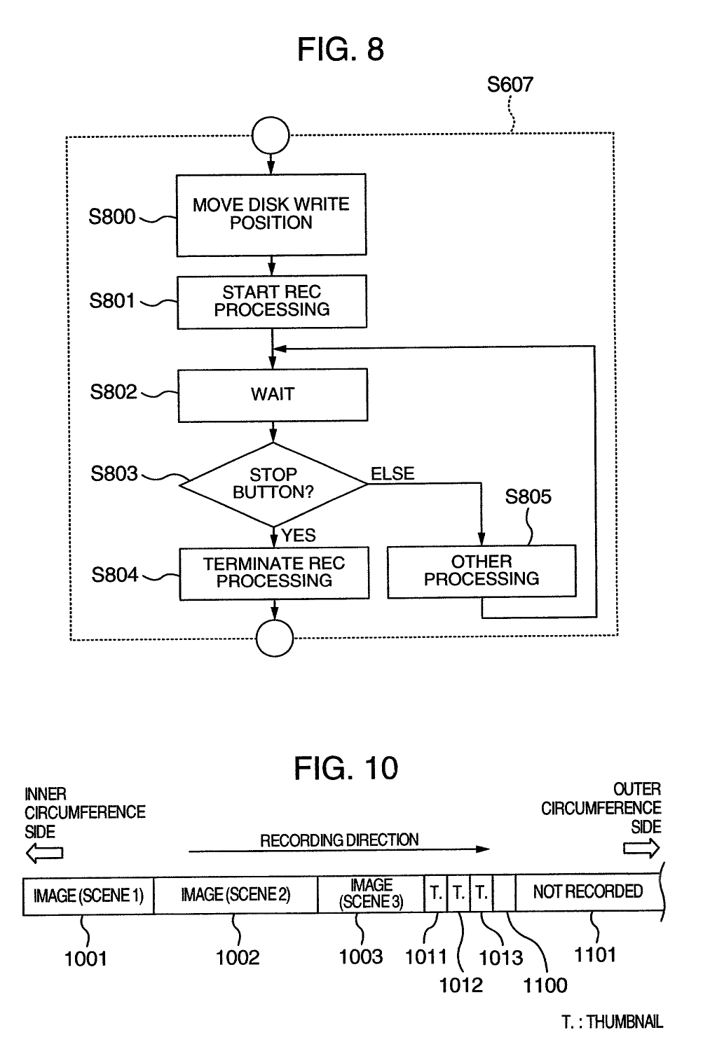

Referring now to FIG. 8, description will be given of REC processing B in step S607 for a write-once optical disk in FIG. 6.

First, step S800 is executed to move the optical pickup device over an area of the optical disk to write record data to resultantly set a write start position. In step S801, a REC operation is started to execute processing assigned to the REC button. During the REC processing, the system state is set to the wait state S703. Resultantly, the system is in a state to receive a key operation from the user. When the user depresses a button thereafter, control is passed by step S803 to processing assigned to the button. If STOP button is depressed, REC termination processing executed in step S804. That is, a system stream which is accumulated in the buffer memory 510 and which is not written on the recording medium is written on the medium. Next, the REC processing B of Step S607 is terminated.

On the other hand, when the user depresses a button other than STOP button, step S805 is executed to execute processing assigned to the depressed button, and then control returns to the wait state S802. The depression of the button other than STOP button indicates, for example, an operation to change a picture quality mode. However, the processing of step S802 is not directly related to the present invention and will not be described in detail.

REC processing of step B S607 differs from REC processing A of step S606 in that the generation and recording of thumbnail data are not conducted for each termination of the REC processing. The generation of thumbnail data is not executed for each REC processing, that is, the thumbnail data is generated once for all REC processing in the finalization in step S609.

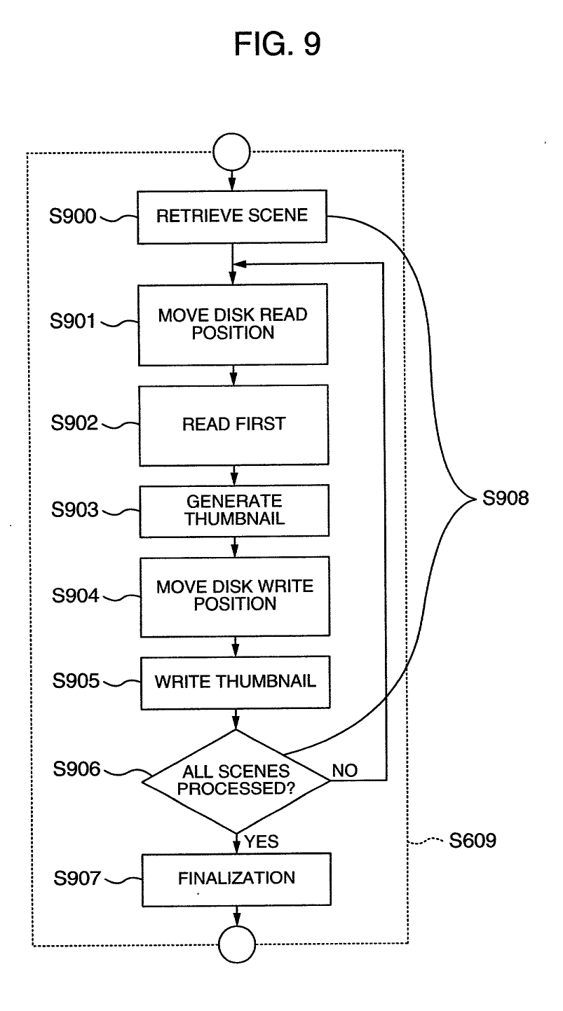

Referring now to FIG. 9, description will be given in detail of the finalization in step S609 shown in FIG. 6.

First, scene retrieval step S900 is executed to execute step S901 to a write start position of the disk. In step S902, thumbnail data which has been recorded on the disk to generate thumbnail for each scene, specifically, a first image of each scene is retrieved from the disk. Next, the image read from the disk in step S903 is minimized into a thumbnail. Step S904 is then executed to set the write position to an end of data written on the disk. In step s905, the thumbnail data is written on the disk. As can be seen from a loop S908, the operation is repeatedly executed for all scenes recorded on the disk according to the determination in step S906.

The finalization step S907 executes operations, for example, an operation to write “0” in all areas of all unused tracks to thereby terminate the finalization step S609.

In usual cases, the finalization takes a relatively long period time. It is therefore safe and efficient to conduct during the finalization the operation, which takes a relatively short period of time, to generate thumbnail data to record the data on the disk.

Referring now to FIG. 10, description will be given of a list of data generated on the write-once disk by the processing described above. Thumbnail data is recorded only after the finalization. Therefore, the image data items respectively of scenes 1 to 3 are continuously recorded as image data items 1001 to 1003 on the disk. Next, thumbnail data items 1011 to 1012 respectively generated for to the scenes 1 to 3 immediately before the finalization are continuously recorded on the disk. An area 1100 is an logically last area of the optical disk generated by the finalization. An area 1101 is an unused area.

As can be seen from FIG. 10, since the thumbnail data items are continuously arranged also on the write-once optical disk, the navigation speed can be guaranteed.

In the description of the embodiment, the thumbnail generation at the end of recording operation on the write-once optical disk is not carried out for each REC processing. However, It is also possible that the thumbnail data is generated for each REC operation such that the data is separately recorded, for example, in the working memory 511. In the finalization, the thumbnail data is read from the working memory 511 to be recorded on the disk. As a result, even an apparatus not coping with the thumbnail data prepared in a continuous layout according to the present invention can achieve the navigation using the thumbnail data generated for each REC operation.

In the description of the embodiment, in the finalization for the write-once optical disk, the thumbnail data is written on the disk each time the data is read from the memory. However, it is also possible that the thumbnail data items of all scenes are read from the memory to be written on the disk at a time. It is favorable that a string of thumbnail data items are written on the optical disk. It is more favorable that the thumbnail data items are written as a single file.

In the description of the embodiment, the recording medium is an optical disk. However, it is to be appreciated that the present invention is also applicable to a digital video disk (DVD) and a compact disk (CD).

Although the description of the embodiment has been given by assuming that the recording and reproducing apparatus can handle the rewritable and write-once optical disks, it is also possible that the apparatus can handle only the write-once optical disk.

According to the embodiment of the present invention as described above, by recording a string or sequence of thumbnail data items, high-speed navigation can be achieved. When the disk type is discriminated, thumbnail data can be recorded according to the disk type. Even when a write-once optical disk medium is used, the navigation can be conducted at a high speed. It is therefore possible to implement a thumbnail generating and recording method suitable for the rewritable and write-once optical disks.

It should be further understood by those skilled in the art that the foregoing description has been made on embodiments of the invention and that various changes and modifications may be made in the invention without departing from the spirit of the invention and the scope of the appended claims.

1. An optical disk recording apparatus, comprising:
recording means for recording at least image data on an optical disk medium; and
thumbnail generating means for generating, for each partial recording section of image data to be recorded on said optical disk medium, thumbnail data of a particular image associated with the partial recording section, the thumbnail data being recorded on said optical disk medium by said recording means, wherein:
when a particular operation is conducted, the particular image is read for each of the partial recording sections;
said thumbnail generating means generates thumbnail data for the particular image read for said each partial recording section;
said recording means recording the thumbnail data of a plurality of images in the form of a string of data.

2. An optical disk recording apparatus according to claim 1, wherein:
said optical disk medium is of a write-once type; and
when an operation for write processing termination is conducted as the particular operation, the string of thumbnail data is recorded.

3. An optical disk recording apparatus according to claim 1, wherein:
said optical disk medium is of a write-once type; and
each time an operation for REC processing is conducted as the particular operation, thumbnail data is generated for the particular operation and is separately kept as a string of thumbnail data; and
when an operation for write processing termination is conducted as the particular operation, the string of thumbnail data is recorded.

4. An optical disk recording apparatus capable of recording data on a plurality of types of optical disk media; comprising:
recording means for recording at least image data on an optical disk medium;
thumbnail generating means for generating, for each partial recording section of image data to be recorded on said optical disk medium, thumbnail data of a particular image associated with the partial recording section, the thumbnail data being recorded on said optical disk medium by said recording means; and
means for determining a type of said optical disk medium and for changing the processing to generate and to record thumbnail data in association with the recording of the image.

5. An optical disk recording apparatus according to claim 4, wherein:
said optical disk medium is of a write-once type; and
when an operation for write processing termination is conducted as the particular operation, the string of thumbnail data is recorded.

6. An optical disk recording apparatus according to claim 4, wherein:
said optical disk medium is of a write-once type; and
each time an operation for REC processing is conducted as the particular operation, thumbnail data is generated for the particular operation and is separately kept as a string of thumbnail data; and
when an operation for write processing termination is conducted as the particular operation, the string of thumbnail data is recorded.

7. An optical disk recording method, comprising the steps of:
recording at least image data on an optical disk medium;
generating, for each partial recording section of the image data, thumbnail data of a particular image associated with the partial recording section and recording the thumbnail data;
reading, when a particular operation is conducted, the particular image for each of the partial recording sections;
generating thumbnail data for the particular image read; and
recording the thumbnail data of a plurality of images in the form of a string of data.

8. An optical disk recording method according to claim 7, wherein said optical disk medium is of a write-once type, said method further comprising the steps of:
generating, when an operation for write processing termination is conducted as the particular operation, thumbnail data for each of the string of partial recording sections; and
recording the thumbnail data generated by the generating step after the string of partial recording sections.

9. An optical disk recording method according to claim 7, wherein said optical disk medium is of a write-once type; said method further comprising the steps of:
generating, each time an operation for REC processing is conducted as the particular operation, thumbnail data is generated for the particular operation and separately keeping the thumbnail data as a string of thumbnail data; and
recording, when an operation for write processing termination is conducted as the particular operation, the string of thumbnail data after the partial recording sections.

10. An optical disk recording method, comprising the steps of:
recording at least image data on an optical disk medium;
generating, for each partial recording section of the image data, thumbnail data of a particular image associated with the partial recording section and recording the thumbnail data;
recording data on a plurality of types of optical disk media;
determining a type of said optical disk medium; and
changing the processing to generate and to record thumbnail data in association with the recording of the image.

11. An optical disk recording method according to claim 10, further comprising the steps of:
generating, when it is determined that said optical disk medium is of a write-once type and when an operation for write processing termination is conducted as the particular operation, thumbnail data for the partial recording section; and
recording the thumbnail data generated by the generating step.

12. An optical disk recording method according to claim 10, further comprising the steps of:
generating, when it is determined that said optical disk medium is of a write-once type and an operation for REC processing is conducted as the particular operation, thumbnail data for the particular operation and separately keeping the thumbnail data as a string of thumbnail data; and
recording, when an operation for write processing termination is conducted as the particular operation, the string of thumbnail data after the partial recording sections, the recording being conducted as an update operation.
